(19) United States
(12) Patent Application Publication
(10) Pub. No.: US 2009/0260004 A1
(43) Pub. Date: Oct. 15, 2009

(54) COMPUTER PROGRAM UPDATES FOR MOBILE COMPUTING DEVICE

(75) Inventors: Mainak Datta, Fremont, CA (US); Andrew Stewart, Palo Alto, CA (US); James (Jianhua) Fan, Palo Alto, CA (US); Sateesh Krishna Shiradwade, San Jose, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/101,004

(22) Filed: Apr. 10, 2008

(51) Int. Cl. G06F 9/445

(52) U.S. Cl. 717/175

(57) ABSTRACT

A system and method for updating a computer program on a mobile computing device comprises uploading of packages to a repository, wherein each package comprises update data for a different portion of the computer program, a server identifying portions of the computer program to be updated on a device based on comparing information reported by the device and metadata about packages in the repository and a download server configured to wirelessly download the packages to the mobile computing device. The device may report back installation status to a server.

### BACKGROUND

Mobile computing devices, such as smart phones, personal digital assistants, and mobile phones, operate various functions based on one or more computer programs stored in memory. From time to time, a manufacturer of the mobile computing device or other party may wish to update the computer program for any of a variety of reasons, such as to fix bugs found in the computer program, add features or functionality, etc.

### BRIEF DESCRIPTION OF THE DRAWINGS

FIGS. 1A through 1F illustrate a mobile computing device from various views, according to an exemplary embodiment;

FIG. 2 is a block diagram of the mobile computing device of FIGS. 1A through 1F, according to an exemplary embodiment;

FIG. 3 is a block diagram of server and device components configured to implement a computer program update, according to an exemplary embodiment;

FIG. 4 is a flow diagram showing additional details of the exemplary embodiment of FIG. 3;

FIG. 5 is a computer program update tree, according to an exemplary embodiment; and

FIG. 6 is a flow diagram of a method for updating a computer program, according to an exemplary embodiment.

### DETAILED DESCRIPTION OF THE EXEMPLARY EMBODIMENTS

Described herein are embodiments of systems and methods for updating one or more computer programs on a mobile computing device. Some embodiments may reduce the amount of bandwidth on a wireless communication link needed for an update process. Some embodiments may reduce the amount of power required for an update process. Some embodiments may make more use of computer server resources than mobile computing device resources to improve processing speed and reduce interruptions to use of the device by the user. Some embodiments may provide a more granular level of updates from a download server to a mobile computing device. Some embodiments may provide scalability and security by using existing communication protocols and controllers or modifications thereof.

Some embodiments may reduce the number of communications needed between client and server to calculate update data needed and dependencies of the update data. Some embodiments allow updating of only portions of a computer program which are needed, instead of requiring a single, large, monolithic download of a new version of an entire system software.

The teachings herein extend to those embodiments that fall within the scope of the appended claims, regardless of whether they accomplish one or more of the above-mentioned exemplary advantages.

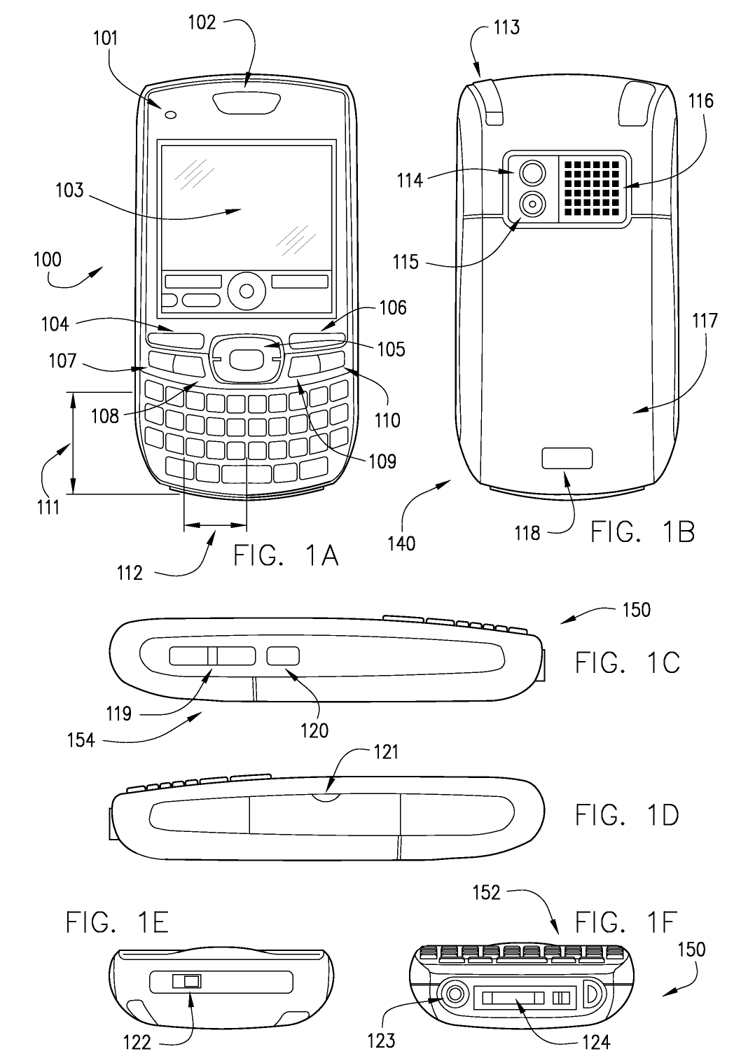

Referring to FIGS. 1A through 1F, a mobile computing device 100 is shown from various angles, according to an exemplary embodiment. FIG. 1A is a front view of device 100; FIG. 1B is a rear view of device 100; FIGS. 1C and 1D are side views of device 100; and FIGS. 1E and 1F are top and bottom views of device 100. The device may be any type of communications or computing device (e.g., a cellular phone, other mobile device, digital media player (e.g., audio or audio/video), personal digital assistant, etc.).

Device 100 may be a smart phone, which is a combination mobile telephone and handheld computer having personal digital assistant (“PDA”) functionality. The teachings herein can be applied to other mobile computing devices (e.g., a laptop computer) or other electronic devices (e.g., a desktop personal computer, etc.). PDA functionality can comprise one or more of personal information management, database functions, word processing, spreadsheets, voice memo recording, location-based services, device backup and lock, media playing, internet browsing, etc. and is configured to synchronize personal information (e.g., contacts, e-mail, calendar, notes, to-do list, web browser favorites, etc.) from one or more applications with a computer (e.g., desktop, laptop, server, etc.). Device 100 is further configured to receive and operate additional applications provided to device 100 after manufacture, e.g., via wired or wireless download, Secure Digital card, etc.

Device 100 may be a handheld computer (e.g., a computer small enough to be carried in a typical front pocket found in a pair of pants or other similar pocket), comprising such devices as typical mobile telephones and PDAs, but the term “handheld” and the phrase “configured to be held in a hand during use” excluding typical laptop computers and tablet personal computers (“PCs”) for purposes of this disclosure. In alternative embodiments, the teachings herein may extend to laptop computers, tablet PCs, desktop PCS, and other electronic devices. The various input devices and other parts of device 100 as described below may be positioned anywhere on device 100 (e.g., the front side of FIG. 1A, the rear side of FIG. 1B, the sides of FIGS. 1C and 1D, etc.).

Device 100 includes various user input devices therein. For example, the user input devices may include a send button 104 usable to select options appearing on display 103 and/or send messages, a 5-way navigator 105 usable to navigate through options appearing on display 103, a power/end button 106 usable to select options appearing on display 103 and to turn on display 103, a phone button 107 usable to access a phone application screen, a calendar button 108 usable to access a calendar application screen, a messaging button 109 usable to access a messaging application screen (e.g., e-mail, text, Multimedia Messaging Service (MMS), etc.), an applications button 110 usable to access a screen showing available applications, a thumb keyboard 111 (which includes a phone dial pad 112 usable to dial during a phone application), a volume button 119 usable to adjust the volume of audio output of device 100, a customizable button 120 which a user may customize to perform various functions, a ringer switch 122 usable to switch the device from one mode to another mode (such as switching from a normal ringer mode to a meeting ringer mode), and a touch screen display 103 usable to select control options displayed on display 103.

Device 100 also includes various audio circuits. The audio circuits may include phone speaker 102 usable to listen to information in a normal phone mode, external speaker 116 louder than the phone speaker (e.g. for listening to music, for a speakerphone mode, etc.), headset jack 123 to which a user can attach an external headset which may include a speaker and/or a microphone, and a microphone that can be used to pick up audio information such as the user's end of a conversation during a phone call.

Device 100 may also include a status indicator 101 that can be used to indicate the status of device 100 (such as messages pending, charging, low battery, etc.), a stylus slot 113 for receiving a stylus usable to input data on touch screen display 103, a digital camera 115 usable to capture images, a mirror 114 positioned proximate camera 115 such that a user may view themselves in mirror 114 when taking a picture of themselves using camera 115, a removable battery 118, and a connector 124 which can be used to connect device 100 to either (or both) an external power supply such as a wall outlet or battery charger or an external device such as a personal computer, a global positioning system (“GPS”) unit, a display unit, or some other external device.

Device 100 may also include an expansion slot 121 that may be used to receive a memory card and/or a device which communicates data through slot 121, and a Subscriber Identity Module (SIM) card slot 117, located behind battery 118, configured to receive a SIM card or other card that allows the user to access a cellular network.

In various embodiments device 100 may include a housing 140. Housing 140 may be configured to retain or secure a screen in a fixed relationship above a plurality of user input devices in a substantially parallel or same plane. A fixed relationship may exclude a hinged or movable relationship between the screen and plurality of keys in the fixed embodiment, though hinged or movable relationships may be used in other embodiments.

Housing 140 could be any size, shape, and dimension. In some embodiments, housing 140 has a width 152 (shorter dimension) of no more than about 200 mm or no more than about 100 mm. According to some of these embodiments, housing 140 has a width 152 of no more than about 85 mm or no more than about 65 mm. According to some embodiments, housing 140 has a width 152 of at least about 30 mm or at least about 50 mm. According to some of these embodiments, housing 140 has a width 152 of at least about 55 mm.

In some embodiments, housing 140 has a length 154 (longer dimension) of no more than about 200 mm or no more than about 150 mm. According to some of these embodiments, housing 140 has a length 154 of no more than about 135 mm or no more than about 125 mm. According to some embodiments, housing 140 has a length 154 of at least about 70 mm or at least about 100 mm. According to some of these embodiments, housing 140 has a length 154 of at least about 110 mm.

In some embodiments, housing 140 has a thickness 150 (smallest dimension) of no more than about 150 mm or no more than about 50 mm. According to some of these embodiments, housing 140 has a thickness 150 of no more than about 30 mm or no more than about 25 mm. According to some embodiments, housing 140 has a thickness 150 of at least about 10 mm or at least about 15 mm. According to some of these embodiments, housing 140 has a thickness 150 of at least about 50 mm. According to some embodiments, housing 140 has a thickness 150 of 11 mm or less.

In some embodiments, housing 140 has a volume of up to about 2500 cubic centimeters and/or up to about 1500 cubic centimeters. In some of these embodiments, housing 140 has a volume of up to about 1000 cubic centimeters and/or up to about 600 cubic centimeters.

Device 100 may include an antenna 130 system for transmitting and/or receiving radio frequency signals. Each transceiver of device 100 may include individual antennas or may include a common antenna 130. The antenna system may include or be implemented as one or more internal antennas and/or external antennas.

While described with regards to a handheld device, many embodiments are usable with portable devices which are not handheld and/or with non-portable devices/systems.

Device 100 may provide voice communications functionality in accordance with different types of cellular radiotelephone systems. Examples of cellular radiotelephone systems may include Code Division Multiple Access (“CDMA”) cellular radiotelephone communication systems, Global System for Mobile Communications (“GSM”) cellular radiotelephone systems, etc.

In addition to voice communications functionality, device 100 may be configured to provide data communications functionality in accordance with different types of cellular radiotelephone systems. Examples of cellular radiotelephone systems offering data communications services may include GSM with General Packet Radio Service (“GPRS”) systems (“GSM/GPRS”), CDMA/1xRTT (1 times Radio Transmission Technology) systems, Enhanced Data Rates for Global Evolution (“EDGE”) systems, Evolution Data Only or Evolution Data Optimized (“EV-DO”) systems, etc.

Device 100 may be configured to provide voice and/or data communications functionality through wireless access points (“WAPs”) in accordance with different types of wireless network systems. A wireless access point may comprise any one or more components of a wireless site used by device 100 to create a wireless network system that connects to a wired infrastructure, such as a wireless transceiver, cell tower, base station, router, cables, servers, or other components depending on the system architecture. Examples of wireless network systems may further include a wireless local area network (“WLAN”) system, wireless metropolitan area network (“WMAN”) system, wireless wide area network (“WWAN”) system (e.g., a cellular network), and so forth. Examples of suitable wireless network systems offering data communication services may include the Institute of Electrical and Electronics Engineers (“IEEE”) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (“PAN”) system, such as a Bluetooth® system operating in accordance with the Bluetooth Special Interest Group (“SIG”) series of protocols.

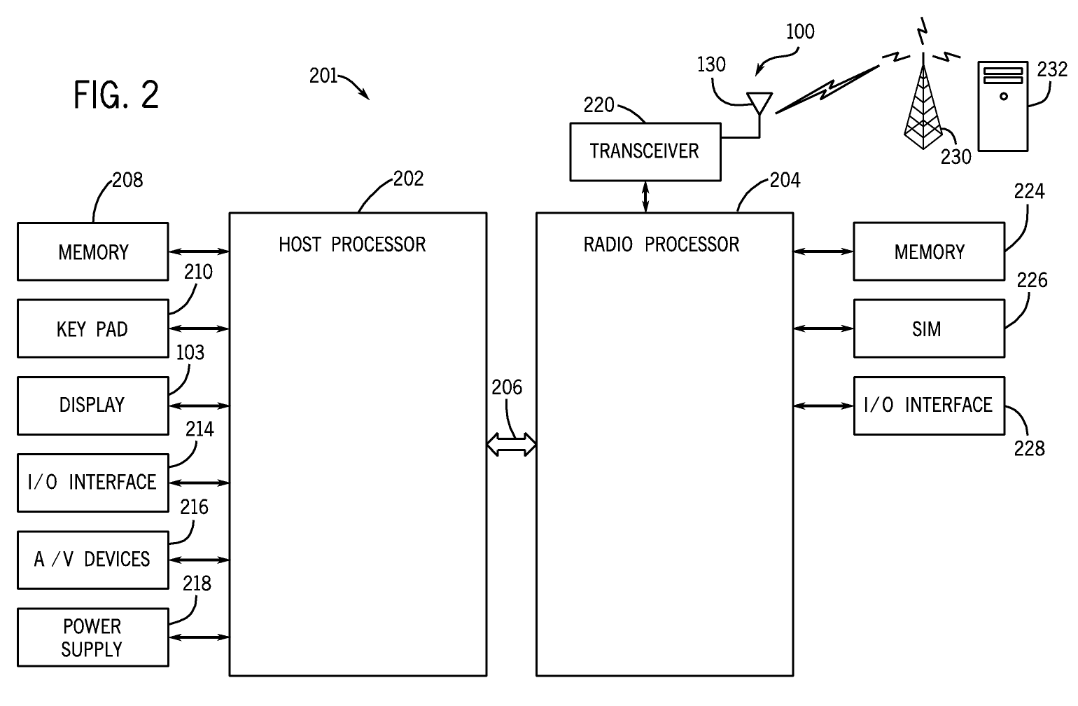

As shown in the embodiment of FIG. 2, device 100 comprises a processing circuit 201, which may comprise a dual processor architecture, including a host processor 202 and a radio processor 204 (e.g., a base band processor or modem). The host processor 202 and the radio processor 204 may be configured to communicate with each other using interfaces 206 such as one or more universal serial bus (“USB”) interfaces, micro-USB interfaces, universal asynchronous receiver-transmitter (“UART”) interfaces, general purpose input/output (“GPIO”) interfaces, control/status lines, control/data lines, shared memory, and so forth.

The host processor 202 may be responsible for executing various computer programs (e.g., software, firmware, or other code) such as application programs and system programs to provide computing and processing operations for device 100. The radio processor 204 may be responsible for performing various voice and data communications operations for device 100 such as transmitting and receiving voice and data information over one or more wireless communications channels. Although embodiments of the dual processor architecture may be described as comprising the host processor 202 and the radio processor 204 for purposes of illustration, the dual processor architecture of device 100 may comprise one processor, more than two processors, may be implemented as a dual- or multi-core chip with both host processor 202 and radio processor 204 on a single chip, etc. Alternatively, a single processor or multiple processors may perform the functions of host processor 202 and radio processor 204, such as a single, unified processor that handles host and radio functions, or other multiprocessor topologies which do not rely on the concept of a host. Alternatively, processing circuit 201 may comprise any digital and/or analog circuit elements, comprising discrete and/or solid state components, suitable for use with the embodiments disclosed herein.

In various embodiments, the host processor 202 may be implemented as a host central processing unit (“CPU”) using any suitable processor or logic device, such as a general purpose processor. The host processor 202 may comprise, or be implemented as, a chip multiprocessor (“CMP”), dedicated processor, embedded processor, media processor, input/output (“I/O”) processor, co-processor, field programmable gate array (“FPGA”), programmable logic device (“PLD”), or other processing device in alternative embodiments.

The host processor 202 may be configured to provide processing or computing resources to device 100. For example, the host processor 202 may be responsible for executing various computer programs such as application programs and system programs to provide computing and processing operations for device 100. Examples of application programs may include, for example, a telephone application, voicemail application, e-mail application, instant message (“IM”) application, short message service (“SMS”) application, multimedia message service (“MMS”) application, web browser application, personal information manager (“PIM”) application (e.g., contact management application, calendar application, scheduling application, task management application, web site favorites or bookmarks, notes application, etc.), word processing application, spreadsheet application, database application, video player application, audio player application, multimedia player application, digital camera application, video camera application, media management application, a gaming application, and so forth. The application software may provide a graphical user interface (“GUI”) to communicate information between device 100 and a user. The computer programs may be stored as firmware on a memory associated with processor 202, may be loaded by a manufacturer during a process of manufacturing device 100, and may be updated from time to time via wired or wireless communication.

System programs assist in the running of a computer system. System programs may be directly responsible for controlling, integrating, and managing the individual hardware components of the computer system. Examples of system programs may include, for example, an operating system (“OS”), a kernel, device drivers, programming tools, utility programs, software libraries, an application programming interface (“API”), a GUI, and so forth. Device 100 may utilize any suitable OS in accordance with the described embodiments such as a Palm OS®, Palm OS® Cobalt, Microsoft Windows® OS, Microsoft Windows® CE, Microsoft Pocket PC, Microsoft Mobile, Symbian OS™, Embedix OS, any Linux distribution, Binary Run-time Environment for Wireless (“BREW”) OS, JavaOS, a Wireless Application Protocol (“WAP”) OS, and so forth.

Device 100 may comprise a memory 208 coupled to the host processor 202. In various embodiments, the memory 208 may be configured to store one or more computer programs to be executed by the host processor 202. The memory 208 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (“RAM”), dynamic RAM (“DRAM”), Double-Data-Rate DRAM (“DDRAM”), synchronous DRAM (“SDRAM)”, static RAM (“SRAM”), read-only memory (“ROM”), programmable ROM (“PROM”), erasable programmable ROM (“EPROM”), electrically erasable programmable ROM (“EEPROM”), flash memory (e.g., NOR or NAND flash memory), or any other type of media suitable for storing information.

Although the memory 208 is shown as being separate from the host processor 202 for purposes of illustration, in various embodiments some portion or the entire memory 208 may be included on the same integrated circuit as the host processor 202. Alternatively, some portion or the entire memory 208 may be disposed on an integrated circuit or other medium (e.g., hard disk drive) external to the integrated circuit of host processor 202. In various embodiments, device 100 may comprise a memory port or expansion slot 121 (shown in FIG. 1) to support a multimedia and/or memory card, for example. Processing circuit 201 may use memory port or expansion slot 121 to read and/or write to a removable memory card having memory, for example, to determine whether a memory card is present in port or slot 121, to determine an amount of available memory on the memory card, to store subscribed content or other data or files on the memory card, etc.

Device 100 may comprise a user input device 210 coupled to the host processor 202. The user input device 210 may comprise, for example, a alphanumeric, numeric or QWERTY key layout and an integrated number dial pad. Device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad and so forth. Examples of such objects are shown in FIG. 1 as 5-way navigator 105, power/end button 106, phone button 107, calendar button 108, messaging button 109, applications button 110, thumb keyboard 111, volume button 119, customizable button 120, and ringer switch 122.

The host processor 202 may be coupled to a display 103. The display 103 may comprise any suitable visual interface for displaying content to a user of device 100. For example, the display 103 may be implemented by a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program.

Device 100 may comprise an I/O interface 214 coupled to the host processor 202. The I/O interface 214 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a PC, or a remote computer system, such as a computer server. In various implementations, device 100 may be configured to transfer and/or synchronize information with the local computer system, such as personal information management data stored in one or more databases in memory 208.

The host processor 202 may be coupled to various audio/video (“A/V”) devices 216 that support A/V capability of device 100. Examples of A/V devices 216 may include, for example, a microphone, one or more speakers, an audio port to connect an audio headset, an audio coder/decoder (codec), an audio player, a digital camera, a video camera, a video codec, a video player, and so forth.

The host processor 202 may be coupled to a power supply 218 configured to supply and manage power to the elements of device 100. In various embodiments, the power supply 218 may be implemented by a rechargeable battery, such as a removable and rechargeable lithium ion battery to provide direct current (“DC”) power, and/or an alternating current (“AC”) adapter to draw power from a standard AC main power supply.

As mentioned above, the radio processor 204 may perform voice and/or data communication operations for device 100. For example, the radio processor 204 may be configured to communicate voice information and/or data information over one or more assigned frequency bands of a wireless communication channel. The radio processor 204 may be implemented as a communications processor using any suitable processor or logic device, such as a modem processor or baseband processor. The radio processor 204 may comprise, or be implemented as, a digital signal processor (“DSP”), a media access control (“MAC”) processor, or any other type of communications processor in accordance with the described embodiments. Radio processor 204 may be any of a plurality of modems manufactured by Qualcomm, Inc. or other manufacturers.

Device 100 may comprise a transceiver 220 coupled to the radio processor 204. The transceiver 220 may comprise one or more transceivers configured to communicate using different types of protocols, communication ranges, operating power requirements, RF sub-bands, information types (e.g., voice or data), use scenarios, applications, and so forth. For example, transceiver 220 may comprise a Wi-Fi transceiver and a cellular or WAN transceiver configured to operate simultaneously.

The transceiver 220 may be implemented using one or more chips as desired for a given implementation. Although the transceiver 220 is shown as being separate from and external to the radio processor 204 for purposes of illustration, in various embodiments some portion or the entire transceiver 220 may be included on the same integrated circuit as the radio processor 204.

Device 100 may comprise an antenna system 130 for transmitting and/or receiving electrical signals. As shown, the antenna system 130 may be coupled to the radio processor 204 through the transceiver 220. Radio tower 230 and server 232 are shown as examples of potential objects configured to receive a signal from antenna system 130.

Device 100 may comprise a memory 224 coupled to the radio processor 204. The memory 224 may be implemented using any type of memory described with reference to memory 208. Although the memory 224 is shown as being separate from and external to the radio processor 204 for purposes of illustration, in various embodiments some portion or the entire memory 224 may be included on the same integrated circuit as the radio processor 204. Further, host processor 202 and radio processor 204 may share a single memory.

Device 100 may comprise a SIM 226 coupled to the radio processor 204. SIM 226 may comprise, for example, a removable or non-removable smart card configured to encrypt voice and data transmissions and to store user-specific data for allowing a voice or data communications network to identify and authenticate the user. SIM 126 also may store data such as personal settings specific to the user.

Device 100 may comprise an I/O interface 228 coupled to the radio processor 204. The I/O interface 228 may comprise one or more I/O devices to enable wired (e.g., serial, cable, etc.) and/or wireless (e.g., WiFi, short range, etc.) communication between device 100 and one or more external computer systems.

In various embodiments, device 100 may comprise location or position determination capabilities. Device 100 may employ one or more position determination techniques including, for example, GPS techniques, Cell Global Identity (“CGI”) techniques, CGI including timing advance (“TA”) techniques, Enhanced Forward Link Trilateration (“EFLT”) techniques, Time Difference of Arrival (“TDOA”) techniques, Angle of Arrival (“AOA”) techniques, Advanced Forward Link Trilateration (“AFTL”) techniques, Observed Time Difference of Arrival (“OTDOA”), Enhanced Observed Time Difference (“EOTD”) techniques, Assisted GPS (“AGPS”) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc.

In various embodiments, device 100 may comprise dedicated hardware circuits or structures, or a combination of dedicated hardware and associated software, to support position determination. For example, the transceiver 220 and the antenna system 130 may comprise GPS receiver or transceiver hardware and one or more associated antennas coupled to the radio processor 204 to support position determination.

The host processor 202 may comprise and/or implement at least one location-based service (“LBS”) application. In general, the LBS application may comprise any type of client application executed by the host processor 202, such as a GPS application configured to communicate position requests (e.g., requests for position fixes) and position responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (“POI”) such as restaurants, hotels, landmarks, and entertainment venues, and other types of LBS services in accordance with the described embodiments.

Radio processor 204 may be configured to generate a position fix by configuring a position engine and requesting a position fix. For example, a position engine interface on radio processor 204 may set configuration parameters that control the position determination process. Examples of configuration parameters may include, without limitation, location determination mode (e.g., standalone, Mobile Station-assisted, Mobile Station-based), actual or estimated number of position fixes (e.g., single position fix, series of position fixes, request position assist data without a position fix), time interval between position fixes, Quality of Service (“QoS”) values, optimization parameters (e.g., optimized for speed, accuracy, or payload), Position Determination Entity address (e.g., IP address and port number of LPS or MPC), etc. In one embodiment, the position engine may be implemented as a QUALCOMM® gpsOne® engine.

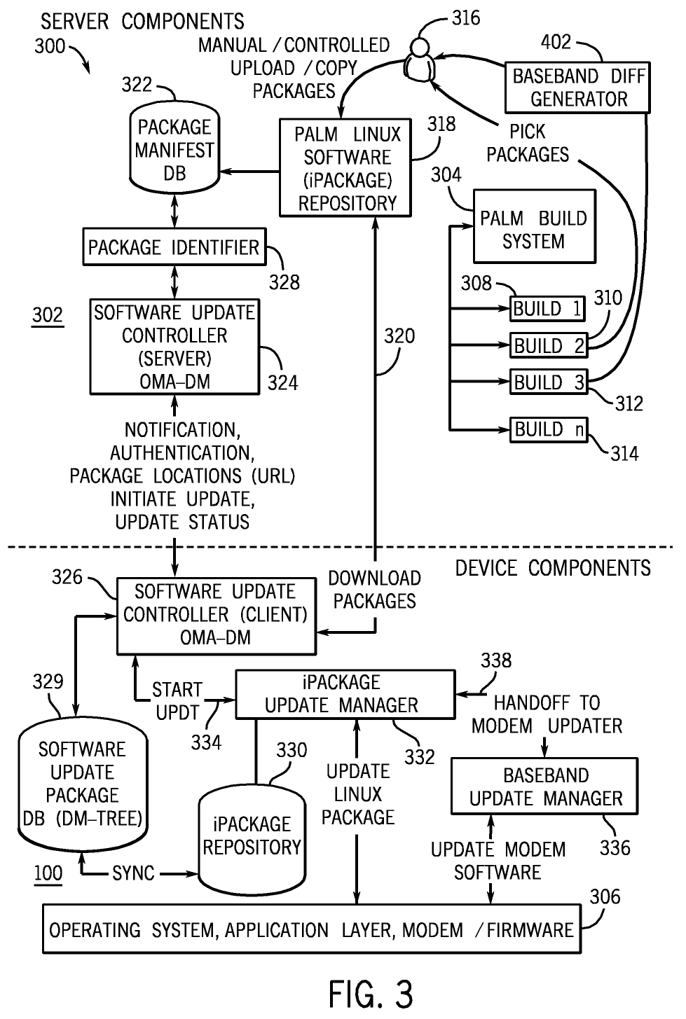

FIG. 3 is a block diagram of a system 300 comprising server and device components configured to implement a computer program update according to an exemplary embodiment. In this embodiment, computer program updates are made to an operating system, applications operable on the operating system (such as any of the applications described herein), and a modem program stored as firmware 306, though the teachings herein may be applied to update other computer programs operable on device 100. Advantageously, computer program updates may be made on portions of a computer program on a package by package level instead of updating the entire, monolithic firmware computer program. Each package may correspond to a portion of firmware 306, such as a binary file, shared library, kernel, driver, application, or other portion or component of firmware 306. In an exemplary embodiment, each portion may be a Linux component or other software or firmware component of an application or computer program. Packages may be created using a Linux-based distribution and may be created as iPackages (i.e. ipkg) or dPackages. An ipkg is an archive containing three objects: a text string, a Tape ARchive (TAR) file containing control information and a TAR file containing data.

In one embodiment, a computer program is loaded on device 100 during manufacture in the form of firmware with an operating system, applications, and other firmware components. The computer program may be a system partition in firmware comprising system files (e.g., files provided with the device by the manufacturer, such as messaging applications, a calendar application, a camera application, etc.) which may be read-only files. A software tool may be used to change the system partition from read-only mode to a read-write mode to allow for an update to the system partition and to return the system partition to a read-only mode after updates. In an embodiment in which the computer program is a system partition, the firmware may comprise a second partition for user data which is commonly changed during use of device 100 (e.g., contacts, calendar appointments, draft documents, etc.). Firmware updates can be carried out on predetermined identified portions of the system partition without updating the second, user partition. In an alternative embodiment, the user partition, too, may be updated. The system partition may further include applications developed by third parties (other than the manufacturer of device 100) which may be updated along with the system partition. The software update process described in FIG. 3 updates the system partition only in this exemplary embodiment.

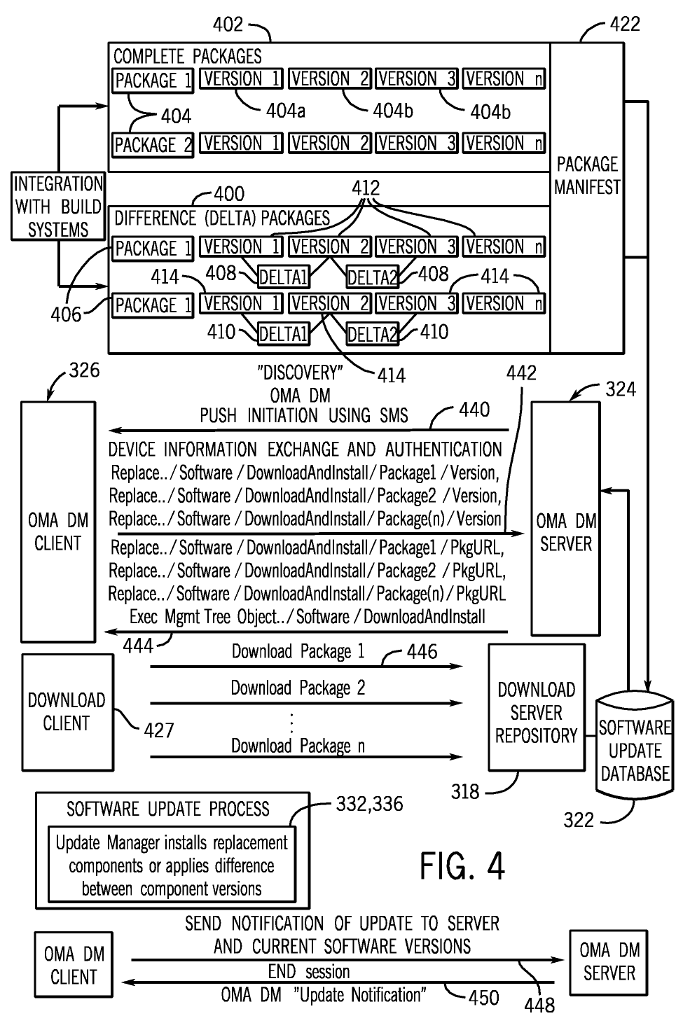

On a server side 302, the components shown may be implemented on one or more computers operable by the same or different parties at the same or different physical locations. Reference to a “server” or “server computer” herein may comprise one or a plurality of computing units disposed at one or a plurality of physical locations and operable by one party or different parties. A build system 304 is used to create computer programs and/or update data for computer programs on firmware 306, which may be stored as one or more computer program builds 308, 310, 312, and 314. The build system 304 may be configured to create builds of update data in the format of packages, which will be described in greater detail with reference to FIG. 4. A baseband diff generator 402 will also be described in greater detail with reference to FIG. 4. Build system 304 may be configured to build a package for a particular model and wireless carrier of device 100, or packages usable by multiple models and/or wireless carriers, as specified in a manifest associated and stored with each package. Build system 304 may further be used to create archive files (e.g., TAR files) comprising one or more packages of update data, along with metadata, such as a manifest for each archive file to be added to the archive file. The manifest may be a text file and may comprise package name, package version, package dependencies, and other information about the package or packages stored in the archive file.

An archive of packages as described above is then selected, for example manually by a system operator 316 or without human input using a computer-based controlled upload, for uploading to a repository 318. Repository 318 may be a storage location from which packages may be downloaded, as indicated by line 320. Repository 318 may be an Internet-based server, in which the packages may be accessed using a resource locator or package location, such as a Uniform Resource Locator (URL). Repository 318 may be configured to store packages in an iPackage format compatible with a Linux-based distribution, or any other formats compatible with other computer programs. A repository may be a directory containing packages along with an index file. Repository 318 is configured to look at the manifest and create metadata from that information and store updated packages.

A software update controller 324 (or computer program update controller) on server side 302 is configured to communicate with a software update controller 326 on device 100. Package manifest database 322 is built using the manifest files for all archive files uploaded from build system 304. Manifest files may be text or metadata files comprising package name, extension, and other package-related data (e.g., dependencies, versions, etc.) for packages in repository 318. The manifest file is part of the archive file consisting of packages of update data. Package manifest database 322 may be updated at the same time when the packages from archive are uploaded to the repository. Package manifest database 322 is used by server update controller 324 to identify program updates that client update controller 326 needs to receive from repository 318. A package identifier 328 is an extension to the server update controller that identifies the updates needed by the device. Software update controller 324 also notifies mobile devices of program updates that they should receive from time to time. These notifications may be sent in batches.

In this exemplary embodiment, messages between server 302 and devices 100 may be communicated using an OMA-DM (Open Mobile Alliance for Device Management) communication protocol. OMA-DM protocols uses a markup language SyncML. OMA-DM protocols may use any data transport layer, such as a wired layer (e.g., USB, RS-232, etc.) or wireless layer (GSM, CDMA, IrDA, Bluetooth, etc.), and may be implemented over any of a wireless application protocol (WAP), HTTP, Object Exchange (OBEX), or other transports. OMA-DM protocols may use a request-response message exchange method in which a requestor sends a request message to a replier system which receives and replies to the request with a response message. OMA-DM protocols may use authentication and/or security on server side 302 and/or device side 100 (e.g., which may be a mutual authentication) to identify the senders of each message. OMA-DM protocols may initiate a communication session from a server, which may occur asynchronously, and may use WAP push, SMS, or other messaging systems. OMA-DM protocols may initiate a communication with a notification or alert message from server 302 to device 100 to notify device 100 of a desire to establish a communication session. While this exemplary embodiment is described with reference to OMA-DM protocol, other protocols having one or more of the characteristics described above or other characteristics may be used.

In response to a notification message from software update controller 324, controller 326, configured to operate as an OMA-DM client, is configured to authenticate the server 302 based on the notification message. If authentic, controller 326 sends a return message. Controllers 324 and 326 then coordinate using an OMA-DM protocol to download a list of packages (e.g., a plurality of resource locators), initiate an update process, and communicate update states, each of which steps may be operable at a software layer higher than a top layer of the OMA-DM communications. These steps will be described in greater detail with reference to FIGS. 4-6.

Controller 326 is configured to download packages using downloaded resource locators wirelessly by accessing the resources in repository 318. Controller 326 is configured to store a file indicating the packages to be downloaded. Once communication with the OMA-DM server 324 is complete, controller 326 uses a secure protocol (such as HTTPS or Hypertext Transfer Protocol over Secure Socket Layer) to download packages from the repository 318.

Update managers 332, 336 may be provided to implement an update on firmware 306 using packages stored in repository 330. Update manager 332, 336 may be any package management system or other manager which may search for, organize, install or update and/or otherwise manage packages in repository 330 and/or in memory on device 100. Functions may include verifying checksums, verifying digital signatures to authenticate an origin of packages, applying archivers to manage files, updating computer programs with latest versions, grouping of packages by function, and identifying and managing dependencies so that the updating or installing of a package also includes other packages required for the package. Update managers 332, 336 may be configured to automate the update process such that update occurs without user input, with only one user input, or otherwise with minimal user input. Update managers 332, 336 may be configured to update from binary files, by compiling source code, or otherwise. Update managers 332, 336 may be configured to receive a start update message 334 from controller 326 and, in response, to begin or continue an update process for firmware 306 based on packages from repository 330.

A second update manager 336 is provided which may be different than update manager 332. Update manager 336 may be configured to update a computer program portion of firmware 306 relating to wireless communication, such as a modem or radio processor. Update manager 332 may be configured to send a trigger message 338, such as a handoff message, to modem or baseband update manager 336 and, in response, manager 336 may begin or continue an update process to update modem or other wireless communication software.

Referring now to FIG. 4, a flow diagram illustrates additional details of the exemplary embodiment of FIG. 3. A first package generator 400 and a second package generator 402 may be integrated with build system 304. Package generators 400, 402 may be configured to create update data in the form of packages 404, 406. Packages 404 are complete packages of an entire computer program or component (which may be used to replace an old component or computer program on device 100) to be updated in one or more versions 404a, 404b, 404c of computer programs. Packages 406 are based on data differences 408, 410 between different versions 412, 414 of computer programs. For example, first package generator 400 may be configured to receive builds 308-314 (FIG. 3), to compare builds 308-314 to prior versions 412, 414 of builds, to provide data differences 408, 410 (e.g., deltas, diffs, or other data differences), and to generate packages 406 based on the data differences 408, 410.

Package generators 400, 402 may be configured to generate packages. A package may contain any of a variety of data types, such as binary files, text files, resources, applications, shared libraries, etc. A package may contain one computer program component which may be an application together with all of its personal resource files, or it may contain any subset of such data. A package may comprise a set of files bundled with associated metadata for use by an update manager or package manager. The files may be used for execution of a computer program or may provide added features to a program already installed on the device. A package may be a set of one or more files compressed into an archives Compression may be implemented using a TAR compression or other compression method.

In this embodiment, package generators 400 and/or 402 may be a Linux-based package generator which may be configured to create packages which include any of a variety of Linux components, such as a kernel, drivers, Linux-based applications, a library, a collection of fonts, a web browser, core operating system components, etc. The packages may represent binary data of Linux components. Package generators 400 and/or 402 may be configured to generate packages related to wireless communication computer programs (e.g. firmware), such as baseband components, modem firmware, drivers, etc. Metadata may be any data about data, which in this case may be associated with each package and comprise a package description, package version, any dependencies, etc.

In this embodiment, a package manifest generator 422 is provided between package generators 400, 402 and repository 318. Package manifest generator 422 is configured to create a manifest file which may be a file comprising metadata such as extension and package-related data for packages in repository 318. Packages may be uploaded from package generators 400, 402, upon verification, to repository 318. In this embodiment, package manifest database 322 is configured to receive package metadata from generators 400, 402 for access by server controller 324. Package repository 318 is accessed by software update client controller 326

Update controllers 324 and 326 are shown in FIG. 4. In this illustration, controllers 324 and 326 are shown functionally as having an OMA-DM server and download server, and an OMA-DM client and download client, though the functional blocks may be operable on a single server or client computer, processor, integrated circuit, etc., or multiple computers, processors, etc. in alternative embodiments. As mentioned, while an OMA-DM based protocol and controllers are illustrated to facilitate transport of packages from server to device, alternative protocols and controllers may be used.

FIG. 4 illustrates an exemplary method of updating a computer program on device 100. Steps 440, 442 and 444 may represent a discovery phase in which server and client establish a communication session and server controller 324 identifies portions of the computer program stored on device 100 to be updated. At step 440, server controller 324 is configured to send a notification message or alert (e.g., which may be an SMS, which may be a push message which is initiated by server controller 324 asynchronously) using the OMA-DM protocol to client controller 326. Client controller 326 is configured to authenticate the notification message and, if authentic, to send data 442 relating to computer programs or portions thereof (e.g., binary files, text files, resources, applications, shared libraries, databases, etc.) currently stored in memory on device 100. For example, client controller 326 may be configured to report one, a plurality or all previously-downloaded and/or updated computer program packages and their versions. Client controller 326 may be configured to report other version data relating to different portions of computer programs stored on device 100, and may report the versions by identifying the portions of the computer program (e.g., by identifier, file name, etc.), by identifying packages associated with the portions of the computer program, or using other indications.

Server controller 324 may then be configured to receive the reports or messages comprising package version data from client controller 324 and to identify portions of the computer program on device 100 to be updated. Packages to be updated may be identified by comparing received package version data and package metadata in package manifest database 322. The comparison or calculation of packages needed by device 100 may be performed at an application layer above the layer at which the OMA-DM protocol is operated. Server controller 324 may also be configured to identify whether an identified package is a dependent package on other packages (and in turn whether those other packages depend on further other packages, and so forth) which must also be identified for download so that the first identified package is operable when updated on device 100. Advantageously, performing the comparison, calculation, and/or dependency identification on server controller 324 instead of client controller 326 may reduce wireless bandwidth and power usage on device 100 and may further provide a faster process because server controller 324 may have greater processing resources (e.g., processing speed, computational power, memory, etc.)

Portions of the computer program to be updated may be identified using alternative methods, such as downloading version data from server to client and comparing the downloaded version data with version data on the client for previously-downloaded and/or updated computer program packages. Another alternative for identifying portions to be updated is to download packages and their associated versions to a client device and then receive user selection of packages to be updated. Another alternative for identifying portions to be updated is to use download data stored in an account for the device or user of the device on the server based on data from previous downloads to identify latest versions. As a further feature, server controller 324 may be configured to determine whether to send a notification at step 440 by comparing prestored data about the last version of each package downloaded to device 100 to new packages available in repository 318 from build system 304. Other alternatives are contemplated.

Based on the identifying step, at step 444, server controller 324 is configured to send a list of computer program packages that the server controller 324 has selected for the device. The list comprises resource locator data (e.g., a Uniform Resource Locator or URL, or other resource locator data) for a plurality of packages of update data sent to client controller 326 to identify locations on a download server, which is the download server 318. Client controller 324 may be configured to replace its resource locators associated with each package to be updated with the new relevant or needed resource locators (e.g., PkgURL) received from server controller 324.

In response to a request to download identified packages at step 446, the download server 318 serves the package from its repository 318.

An execute command is issued, such as near or at the end of the OMA-DM communication session, to trigger a local update process on device 100 using update manager 332 and/or 336, as described in FIG. 3. The execute command may be issued by server controller 324 and/or client controller 326. As shown in FIG. 4, update manager 332 and/or 336 may be configured to install replacement components or apply difference packages between component versions.

At step 448, client controller 326 sends a notification of update to server controller 324 and current computer program versions. Server controller 324 is configured to store this data and may be configured to use this data to determine whether it needs to send another list of packages to the software update client controller

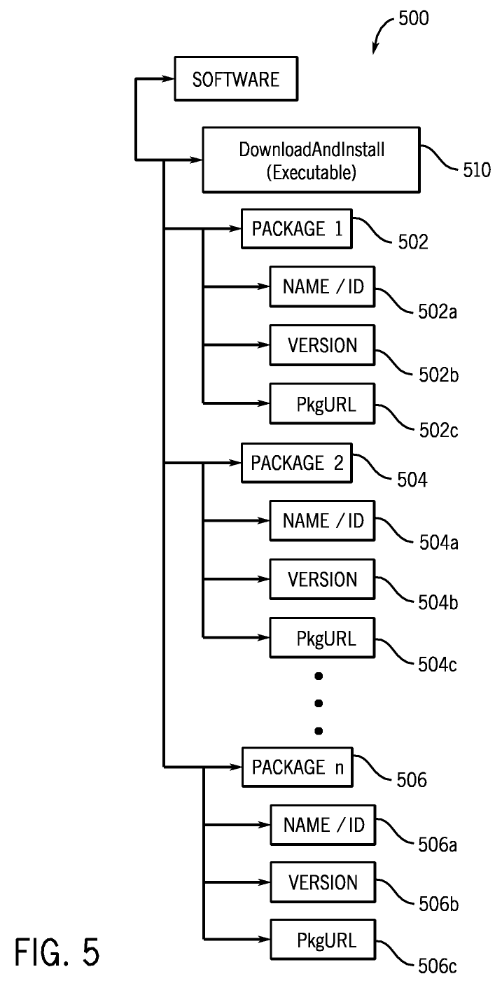

Referring to FIG. 5, an exemplary tree structure for a plurality of downloaded computer program packages is shown. As shown in FIG. 3, server controller 324 is configured to send a list or file which may comprise one or more of the data shown in the tree structure of FIG. 5 to client controller 326. Client controller 326 is configured to store this list in update package database 328. The list should represent the packages downloaded by client controller 326 and stored in repository 330. If it does not, controller 326 may be configured to request any missing files from the download server. Tree structure 500 comprises a node for each package of update data 502, 504, 506, each node comprising a package name or identifier 502a, 504a, 506a, a version 502b, 504b, 506b, a resource locator 502c, 504c, 506c, and any other data, such as status, etc. Upon receipt of an execute or start update command 334 (FIG. 3), update managers 332 and/or 336 may be configured to reference the list in database 328 and begin the local update process with package 1 502. In one embodiment, nodes for computer program components for both update managers 332 and 336 (and others, if used) may be stored under one root node 510 and the execute command may be triggered on root node 510 so that updating proceeds with all update data. Alternatively, a plurality of root nodes having tree structures may be used for different update managers.

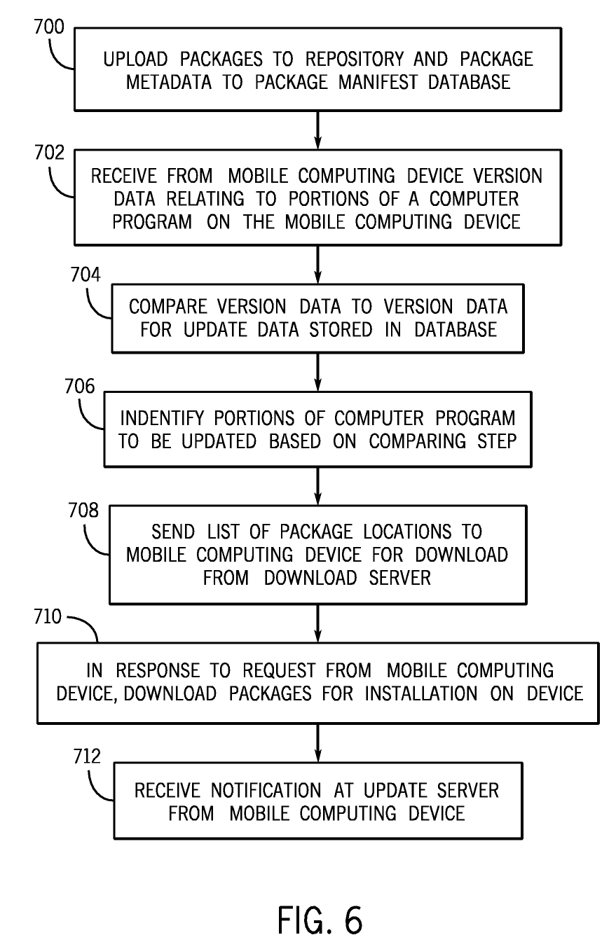

Referring to FIG. 6, a method of computer program update will be described according to another exemplary embodiment. The method may be carried out by one or more of the features described herein with reference to other figures. At step 700, the method operates on the server side to upload packages to repository 318 and package metadata to package manifest database 322. At step 702, the method comprises receiving from the mobile computing device version data relating to each of a plurality of portions of the computer program on the mobile computing device. At step 704, the method comprises comparing the version data to version data or other metadata for update data stored in a database (e.g., repository 318). At step 706, the method comprises identifying the portions of the computer program to be updated based on the comparing. At step 708, the method comprises sending a list of package locations to mobile computing device 100 for download from repository 318. At step 710, repository 318 receives a request from device 100 to download packages for installation on device 100, for example by receiving package locations or resource locators, and downloads the packages. At step 712, server 324 receives notification from device 100 which may comprise version data for computer programs or components thereof having been updated.

The embodiments disclosed herein have been described with reference to block diagrams and flow diagrams. Each block may represent one or more computer programs (e.g., software, firmware, etc.) and/or the hardware or processing circuitry on which the computer programs operate (e.g., microprocessors, microcontrollers, applications-specific integrated circuits, programmable logic, programmable gate array, etc.). Use of the term module herein may refer to either computer program and/or circuit components operating the computer program to carry out the functions described herein. Modules may interface with other modules at a hardware and/or computer program level, and may operate at and/or interface with other modules at any applicable computer program level specified in the Open Systems Interconnection (OSI) model, such as application layer, presentation layer, session layer, transport layer, network layer, data link, physical layer, etc. Modules may be represented by a block, multiple blocks or portions of blocks in the various figures herein.

What is claimed is:

1. A method of updating a computer program on a mobile computing device, comprising:
at a server computer, receiving version data from the mobile computing device for portions of a computer program;
identifying portions of the computer program to be updated on the mobile computing device based on the version reported by the mobile computing device and based on metadata in the database; and
sending a list of packages to the mobile computing device based on the identified portions of the computer program to be updated.

2. The method of claim 1, wherein the method further comprises, at the server computer, initiating a communication session with the mobile computing device, wherein the server computer comprises a software update server.

3. The method of claim 2, wherein the communication session is initiated using a request-response protocol.

4. The method of claim 3, wherein the request-response protocol comprises an OMA-DM protocol.

5. The method of claim 1, wherein the list of packages comprises resource locator data identifying locations on a download server of packages to be downloaded.

6. The method of claim 1, wherein the packages have been created using a Linux-based package distribution.

7. The method of claim 1, wherein the computer program comprises firmware configured to operate a plurality of different applications for a user of the mobile computing device.

8. The method of claim 7, wherein the plurality of different applications comprise an e-mail messaging application and a contacts application

9. A system for updating a computer program on a mobile computing device, comprising:
a first server module configured to identify portions of the computer program to be updated;
a second server module to generate a package list based on information from a database and the mobile device and
a download server module configured to wirelessly download the packages to the mobile computing device.

10. The system of claim 9, further comprising a fourth server module configured to respond to a communication session initiated from the mobile computing device.

11. The system of claim 10, wherein the communication session is initiated using a request-response protocol.

12. The system of claim 11, wherein the request-response protocol comprises an OMA-DM protocol.

13. The system of claim 9, wherein the packages have been created using a Linux-based package distribution.

14. The system of claim 9, wherein the download server module is configured to serve packages representing wireless communication firmware.

15. A method of updating a computer program on a mobile computing device, comprising:
receiving from the mobile computing device version data relating to each of a plurality of portions of the computer program on the mobile computing device;
comparing the version data to version data for update data stored in a database;
identifying the portions of the computer program to be updated based on the comparing; and
wirelessly downloading packages to the mobile computing device based on the identifying step.

16. The method of claim 15, wherein the update data is sent in the form of packages.

17. The method of claim 16, wherein the packages have been created using a Linux-based package distribution.

18. The method of claim 17, wherein the version data is received and the update package list is sent using a request-response protocol.

19. The method of claim 18, wherein the request-response protocol comprises an OMA-DM protocol

20. A mobile computing device, comprising:
a wireless transceiver configured for communication with a remote download server;
a memory configured to store a computer program; and
a processing circuit configured to transmit version data for different portions of the computer program and to receive update data for portions of the computer program to be updated.

21. The mobile computing device of claim 20, wherein the update data is in the form of a package for each portion of the computer program to be updated.

22. The mobile computing device of claim 21, wherein the processing circuit is configured to operate at least two different update managers, wherein at least one of the update managers is configured to update a computer program portion relating to wireless communication.

23. The mobile computing device of claim 22, wherein the processing circuit is configured to receive resource locators for each of a plurality of packages, wherein the update data is received by the processing circuit using the resource locators.

24. The mobile computing device of claim 22, wherein the processing circuit is configured to issue an execute command to the update managers and, in response, the update managers are configured to update different portions of the computer program.
